(19) United States
(12) Patent Application Publication
(10) Pub. No.: US 2005/0002469 A1
(43) Pub. Date: Jan. 6, 2005

(54) Envelope elimination and restoration device

(76) Inventors: Tommy Oberg, Knivsta (SE); Ahmed Hemani, Kista (SE); Daniel Bjork, Sollentuna (SE)

Correspondence Address: HARNESS, DICKEY & PIERCE, P.L.C., P.O. BOX 8910, RESTON, VA, 20195, US

(21) Appl. No.: 10/834,225

(22) Filed: Apr. 29, 2004

(30) Foreign Application Priority Data
May 2, 2003 (SE) 0301277-0

(51) Int. Cl. H04K 1/00

(52) U.S. Cl. 375/295

(57) ABSTRACT

This invention relates to an envelope elimination and restoration device having an input terminal for processing an input signal comprising an inphase signal and a quadrature signal. The envelope elimination and restoration device comprises: a signal pre-processing device, which comprises a first path for processing the envelope of said input signal, and a second path for processing the phase of said input signal, said first path comprising a digital envelope extractor receiving said inphase and quadrature signals, and said second path comprising an intermediate frequency upconverter, receiving said input signal, and generating an intermediate frequency signal comprising said inphase and quadrature signals, and a digital clipping unit receiving said intermediate frequency signal; a power control signal source having an input connected to an output of said envelope extractor; a radio frequency upconverter connected to said digital clipping unit; and a power amplifier having an input, which is connected to an output of said radio frequency upconverter, a power control input, which is connected to an output of said power control signal source, and an output.

### TECHNICAL FIELD

This invention relates to a signal pre-processing device for pre-processing a signal to be transmitted in a radio communication system, and to an envelope elimination and restoration device comprising such a signal pre-processing device.

### TECHNICAL BACKGROUND

Signal pre-processing involves several different steps, such as modulation and power amplification, before an RF signal is actually transmitted. Quality requirements of RF systems put high demands on all parts of the transmission chain. Mobile solutions add a demand for low power solutions, where the efficiency of the RF power amplifier plays an important role. There is a contradiction between efficiency and demands for linearity. This is very pronounced in multicarrier and OFDM (Orthogonal Frequency Division Multiplexing) systems. A prior art solution for dealing with this situation is EER, Envelope Elimination and Restoration. In EER the RF signal is processed in two separate paths, where the magnitude information of the RF signal is separated and amplified in one path, and the phase information represented in a constant envelope signal is amplified in the other path. Typically, in the magnitude path there is provided an envelope detector followed by a low frequency amplifier, and in the phase path there is provided a limiter for clipping the signal and an efficient, but non-linear, amplifier. The power supply of the non-linear amplifier is modulated by the output signal of the low frequency envelope amplifier. The EER principle was described in “Single-sided transmission by envelope elimination and restoration”, Proc IRE, pp 803-806, as early as 1952. Since then, of course, the development in circuit technology has been tremendous, and in the most recent years efforts have been made to use as much CMOS (Complementary Metal Oxide Semiconductor) technology as possible in low power designs. In addition, different attempts have been made to improve the EER solution and adapt it to new kinds of RF communication systems, and to reduce the effects of undesired difference in delay between the magnitude path and the phase path.

In “An IC for linearizing RF power amplifiers using envelope elimination and restoration”, by David Su and William McFarland, Communications and optics research laboratory, HPL-998-186, November 1998, a system for linearizing the EER circuitry, in order to increase the overall efficiency thereof, was disclosed.

U.S. Pat. No. 5,990,735 addresses the problem of ever increasing bandwidths of the magnitude signal, which negatively affects the efficiency of the magnitude path amplifier. The proposed solution of this prior art document is to provide a modulator having a PWM (Pulse Width Modulation) circuit and multiple switch-capacitor stages. However, this solution suffers from harmonic distortion due to the fact that PWM as such is a non-linear operation. Su and McFarland propose delta modulation rather than PWM in order to improve the linearity.

However, the previous EER solutions still suffer from common drawbacks inherent in the basic design of the EER circuitry. These drawbacks include the above-mentioned delay as well as circuit imperfections such as temperature drifts, etc.

Further, the previous EER solutions are not optimal to recent radio communication systems which are based on digital signal processing, such as for example WLAN (Wireless Local Area Network) systems and similar systems supporting the IEEE standards 802.11a and 802.11b, the HiperLAN/2 standard, and the like. In those systems the power amplification circuitry of, for example, transmitters is still typically based on analogue solutions. Efforts have been made to digitalize traditional linear solutions. However, these are non-efficient.

### SUMMARY OF THE INVENTION

The object of this invention is to provide a solution that eliminates, or at least decreases, the above defined drawbacks, and provides for an efficient solution to the power amplification deficiencies.

The object is achieved by a device in accordance with the present invention.

In one aspect thereof the present invention provides for an envelope elimination and restoration device having an input terminal for processing an input signal comprising an inphase signal and a quadrature signal, wherein the envelope elimination and restoration device comprises:
a signal pre-processing device, which comprises a first path for processing the envelope of said input signal, and a second path for processing the phase of said input signal, said first path comprising a digital envelope extractor receiving said inphase and quadrature signals, and said second path comprising an intermediate frequency upconverter, receiving said input signal, and generating an intermediate frequency signal comprising said inphase and quadrature signals, and a digital clipping unit receiving said intermediate frequency signal;
a power control signal source having an input connected to an output of said envelope extractor;
a radio frequency upconverter connected to said digital clipping unit; and
a power amplifier having an input, which is connected to an output of said radio frequency upconverter, a power control input, which is connected to an output of said power control signal source, and an output.

In another aspect thereof, this invention provides for a signal pre-processing device having an input terminal for processing an input signal comprising an inphase signal and a quadrature signal, said pre-processing device comprising a first path for processing the envelope of said input signal, and a second path for processing the phase of said input signal. The first path comprises a digital envelope extractor, which receives said inphase and quadrature signals. An output of the envelope extractor provides a first output of the pre-processing device. The second path comprises an intermediate frequency upconverter, receiving said input signal, and generating an intermediate frequency signal comprising said inphase and quadrature signals; and a digital clipping unit receiving said intermediate frequency signal. An output of the clipping unit provides a second output of the pre-processing device.

A basic idea of the invention is to consider not only the problem of an inefficient final RF power amplification circuitry separately, but rather to start from the inphase and quadrature signals at a relatively low frequency, and try to find a better signal processing solution as a whole, involving also frequency upconversion. The input signal is for example, and preferably, received from a modem as a complex signal at baseband frequency. Thus, the solutions according to the above described aspects of the invention involve the processing preparing the radio communication signal for the final power amplification in an optimal way. The solution involves digital circuitry to a significant extent in the paths for processing the envelope (magnitude path) and phase, which provides for a simplified handling of delays, and reduces problems typically associated with analogue circuits, such as temperature drift. Further, the digital circuitry saves power and enhances the processing accuracy. In addition, the clipping in the phase path is performed at an intermediate frequency, i.e. above the baseband frequency but below radio frequency, which has the advantage of an accurate and stable processing of the phase of the input signal.

In embodiments of the envelope elimination and restoration device and pre-processing device, respectively, according to the present invention, said intermediate frequency upconverter comprises an inphase path having a first input for receiving said inphase signal, and a quadrature path having a second input for receiving said quadrature signal. Each path comprises a first up-sampler, and a second up-sampler.

The division of the up-sampling function is advantageous, since it opens up for a good signal processing which increases the signal quality.

The divided up-sampling is used in other embodiments, where each one of said inphase and quadrature paths, respectively, comprises a low pass filter connected between the first and second up-sampler, and a band pass filter connected to an output of the second up-sampler. On the other hand, embodiments having a single up-sampler performing the same task as the two up-samplers, would be possible. Such embodiments would be advantageous by having a reduced amount of circuits.

In embodiments of said envelope elimination and restoration device and said pre-processing device, said first and second up-samplers and said low pass and band pass filters are arranged such that the frequency content of the band pass signals output from said band pass filters comprise said inphase and quadrature signals. Thus, the band pass signals are well prepared for a following upconversion to radio frequency.

In different embodiments the envelope extractor is connected to either the input terminal or to an output of said intermediate frequency upconverter. In other words it is possible, within the scope of the invention, to use either a baseband frequency or an intermediate frequency signal as an input signal to the envelope extractor.

According to embodiments of the devices, this possibility is realised by means of arranging the envelope extractor for determining the square root of the sum of the square of said inphase signal and the square of said quadrature signal. In other words, the envelope extractor is implemented for digitally performing a simple mathematical operation on the inphase and quadrature signals.

In an embodiment of the envelope elimination and restoration device, the power control signal source comprises a sigma-delta D/A converter providing said input of the power control signal source, and a reconstruction filter having an input connected to an output of said sigma-delta D/A converter and providing said output of the power control signal source. A sigma delta D/A converter, although providing an analogue output has a digital character of its circuits, that is well suited for the aimed at applications of this invention. Further, it contributes to the above stated object of decreasing shortcomings of the prior art, among other things, in that the analogue output signal has a low remaining quantisation noise. Additionally, it provides for an efficient driver stage for the power supply of the power amplifier.

In accordance with an embodiment of the envelope elimination and restoration device said radio frequency upconverter comprises an upconversion unit. The upconversion unit comprises:
a first upconversion gate unit having a first input connected to a first output of said digital clipping unit, and a second input receiving a first digital upconversion signal; and
a second upconversion gate unit having a first input connected to a second output of said digital clipping unit, and a second input receiving a second digital upconversion signal.

Thus, according to this embodiment, the complex as well as the digital nature of the signal is preserved through the RF upconversion by means of gate units. This is emphasized by an embodiment wherein the upconversion unit further comprises a subtraction gate unit having a first input connected to an output of said first upconversion gate unit, and a second input connected to an output of said second upconversion gate unit.

According to embodiments of the envelope elimination and restoration device the first upconversion gate unit comprises a first logic EXOR circuit, which is connected to said first and second inputs of the first upconversion gate unit, the second upconversion gate unit comprises a second logic EXOR circuit, which is connected to said first and second inputs of the second upconversion gate unit, and the subtraction gate unit comprises a logic OR circuit, which is connected to said first and second inputs of the subtraction gate unit. These circuits represent at least a substantial part of a preferred digital implementation of the RF upconverter, where the digital signal character is preserved as long as possible, in order to obtain the optimal use of the above described advantages of digital circuits.

On the other hand, the scope of the invention also includes embodiments representing analogue implementations of the RF upconverter as follows. The radio frequency converter comprises a first bandpass filter having an input connected to a first output of said digital clipping unit; a second bandpass filter having an input connected to a second output of said digital clipping unit; and an upconversion unit having a first input, which is connected to an output of said first bandpass filter, and a second input, which is connected to an output of said second bandpass filter. The upconversion unit comprises a first mixer having a first input connected to said first input of the upconversion unit, and a second input receiving a first analogue upconversion signal; a second mixer having a first input connected to said second input of the upconversion unit, and a second input receiving a second analogue upconversion signal; and a subtractor having a first input connected to an output of said first mixer, and a second input connected to an output of said second mixer. This analogue alternative is advantageous in a situation of large requirements on low radiation outside of the band of interest.

Further objects and advantages of the present invention will be discussed below by means of exemplifying embodiments.

### BRIEF DESCRIPTION OF THE DRAWINGS

Embodiments of the invention will be described below with reference to the accompanying drawings, in which:

FIG. 1 is a schematic block diagram showing a the principal blocks of a general envelope elimination and restoration device;

FIG. 2 is a schematic block diagram of an embodiment of the envelope elimination and restoration device according to the present invention;

FIG. 3 is a schematic block diagram of an embodiment of an envelope processing part of the device shown in FIG. 2;

FIG. 4 is a schematic block diagram of an embodiment of a phase processing part of the device shown in FIG. 2;

FIG. 5 is a schematic block diagram of an embodiment of an RF upconverter of the device shown in FIG. 2;

FIG. 6 is a schematic block diagram of another embodiment of the RF upconverter of the device shown in FIG. 2; and

FIG. 7 is a schematic block diagram of a transmitter comprising the device according to the present invention.

### DESCRIPTION OF EMBODIMENTS

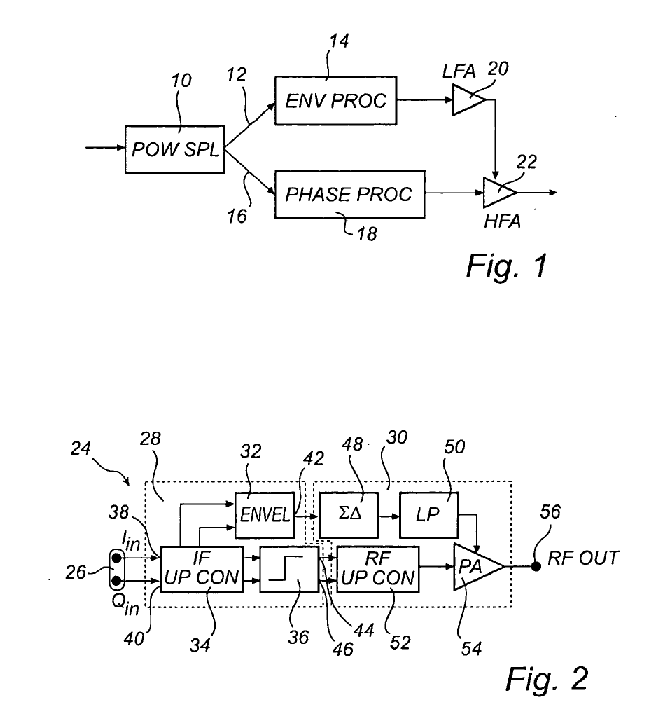

In FIG. 1 a principal block diagram of a general, and prior art, envelope elimination and restoration (EER) device is shown. An input radio frequency signal is received by a power splitter 10, and is split by means of the power splitter 10. One part of the input signal power is fed to an amplitude path, or envelope path, 12 and is received at the input of an envelope processing unit 14. The other part of the input signal power is fed to a phase processing unit 18 comprised in a phase path 16. The output signal, i.e. an envelope signal, of the envelope processing unit 14 is fed to a Low Frequency Amplifier (LFA) 20, and the output signal, i.e. a phase signal, of the phase processing unit 18, which phase signal is at carrier frequency, is fed to a High Frequency Amplifier (HFA) 22. The output of the LFA 20 is connected to a control input of the HFA 22 for modulating the output signal thereof by means of the amplified envelope signal. The resulting output signal is, thus, an amplified radio frequency (RF) signal. The LFA is a linear amplifier, and the HFA is a non-linear but highly efficient amplifier, as also described above when discussing prior art.

The basic principle of individual amplification of an envelope signal and a phase signal having a constant envelope is also applied to the envelope elimination and restoration device according to the present invention, as shown in FIG. 2. However, there are few similarities when it comes to the circuit implementation, as will be explained in the following.

The present invention is preferably made use of in digital wireless radio systems, such as WLANs (Wireless Local Area Network) and mobile phones. Due to the low power and other requirements of devices to be used in such applications, the conventional EER is not attractive. However, in accordance with the present invention the basic functional concept of the EER has been reused, though in a significantly digital realisation, and with many different circuit solutions. Therefore, the envelope elimination and restoration device 24, for the purposes of this application, is called a DEER (Digital EER).

The device 24 takes as an input signal a complex input signal from, typically, a modem. The input signal comprises an inphase (I) signal received at a first input port of an input terminal 26, and a quadrature (Q) signal received at a second input port of the input terminal 26. The I and Q signals are baseband signals, in contrast to the RF input signal of the prior art device. This means that the present device 24 has also up-conversion functions. This has been done in order to achieve the purposes described in the summary above.

The envelope elimination and restoration device 24 comprises a pre-processing device 28, and a further processing part, i.e. a part for further processing, 30 connected to outputs of the pre-processing device 28. More particularly the pre-processing device 28 comprises a first path for processing the envelope of the input signal, which path comprises a digital envelope extractor 32, and a second path for processing a phase of said input signal, which path comprises an intermediate frequency (IF) upconverter 34, and a digital clipping unit 36. The IF upconverter 34 has an I input 38 and a Q input 40, which are each connected to the respective I and Q input ports of the input terminal 26, and an I output and a Q output, which are connected to respective I and Q inputs of the clipping unit 36. The output 42 of the envelope extractor 32, as well as I and Q outputs, 44 and 46 respectively, of the clipping unit 36, embodies outputs of the pre-processing device 28 and are connected to the further processing part 30. The further processing part comprises a sigma delta (ΣΔ) D/A converter 48, which has an input connected to the output 42 of the envelope extractor 32; a reconstruction filter 50, an input of which is connected to an output of the EA converter 48; a radio frequency (RF) upconverter 52, having I and Q inputs connected to the corresponding I and Q outputs 44, 46 of the clipping unit 36, and a power amplifier (PA) 54, having a first input connected to an output of the RF upconverter 52, and a second input, or power control input, connected to an output of the reconstruction filter 50. An output of the PA 54 is connected to the output 56 of the whole envelope elimination and restoration device 24. Thus, the ΣΔ converter 48 and the reconstruction filter 50 continue the envelope path, which is ended at the power control input of the PA 54, and the RF upconverter 52 continues the phase path, which is ended at the first input of the PA 54.

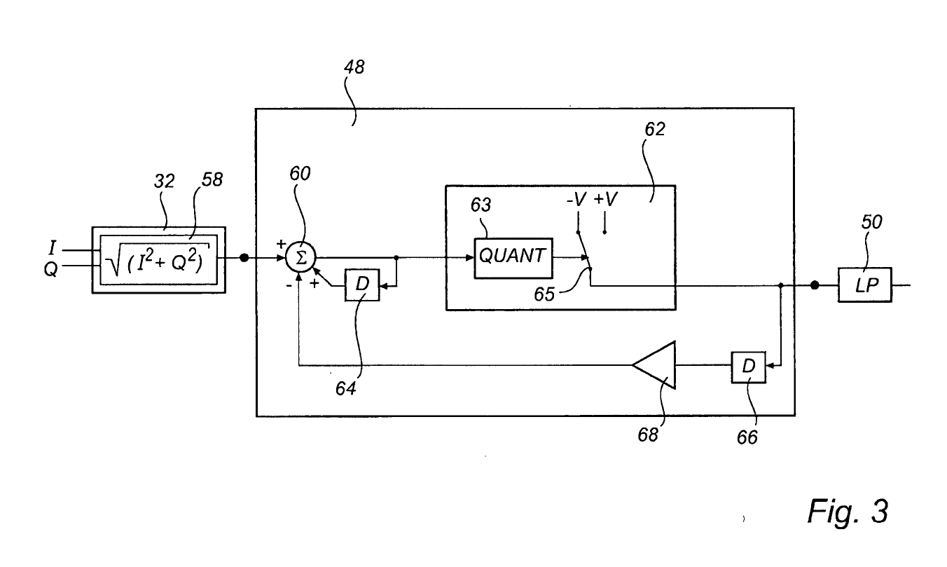

The envelope extractor 32 comprises I and Q inputs, which are connected to either the input terminal 26 or to outputs of the IF upconverter as will be further described below. As shown in FIG. 3, the envelope extractor comprises a computing circuit 58, which determines the envelope by calculating \sqrt{(I²+Q²)}, i.e. the square root of the sum of the square of the I signal and the Q signal. Since the computing circuit is digital, the calculation produces a very accurate value. The output envelope signal is fed to the ΣΔ D/A converter 48, which performs D/A conversion and amplification of the envelope signal. Since the ΣΔ D/A converter 48 is a common circuit well known to a man skilled in the art, it will only be described in short here. The ΣΔ D/A converter 48 comprises an adder 60, having a first input connected to the input of the ΣΔ D/A converter 48, and a limiter 62, having an input connected to an output of the adder 60 and an output connected to the output of the ΣΔ D/A converter 48. Further the ΣΔ D/A converter 48 comprises a first feedback loop comprising a first delay element 64, connected between the output of the adder 60 and a second input, which is a Σ input, thereof; and a second feedback loop comprising a second delay element 66 and an amplifier 68, which are connected in series between the output of the limiter 62 and a third input, which is a Δ input, of the adder 60. Consequently, an output signal of the adder 60 is added to the envelope signal received at the ΣΔ D/A converter 48, and an output signal of the limiter 62, and thus of the ΣΔ D/A converter 48, is subtracted from the envelope signal. The limiter 62 comprises a single bit quantizer 63, and a switch 65, which is controlled by the quantizer 63, and which switches the output of the limiter 62 between +V and −V, where V is a predetermined supply voltage. The circuit, thus enabled, is very power efficient. The ΣΔ D/A converter 48 uses oversampling, which spreads the quantisation noise over a bandwidth that is much larger than the bandwidth of the wanted signal. The output of the ΣΔ D/A converter 48 is a clipped signal, which is then lowpass filtered through the following reconstruction filter 50, resulting in an analogue signal with low remaining quantisation noise. This analogue signal is fed to the power control input of the PA 54.

The IF upconverter 34, in this embodiment, is digitally implemented, and comprises an inphase path 70 extending between the I input and the I output of the IF upconverter 34, and a quadrature path 72 extending between the Q input and the Q output of the IF upconverter 34. Each path comprises a series connection of a first up-sampler 74, 76, a lowpass filter 78, 80, a second up-sampler 82, 84, and a bandpass filter 86, 88. Each one of the first up-samplers 74, 76 upsamples the I and Q signals respectively by a factor of three, i.e. their sampling frequency is 3fₛ, where fₛ is the original sampling frequency of the input signal. For example, when the input signal is derived from a modem in a typical WLAN system the input signal is a modulated signal, and more particularly an OFDM (Orthogonal Frequency Division Multiplexing) signal, having a sampling frequency fₛ of 20 MHz. Then the sampling frequency of the first upsamplers 74, 76 is 60 MHz. The upsampling is performed by zero padding, i.e. logic zero bits are inserted between the original samples. In the given example two zero bits are inserted between every two consecutive original bits. The output signals of the first upsamplers are then lowpass filtered through the lowpass filters 78, 80. Then a second upsampling follows by means of the second upsamplers 82, 84. The second upsampling is done by a factor five, i.e. the sampling frequency of the output signals of the second upsamplers is 15fₛ, i.e. 300 MHz according to the present example. This second upsampling is performed by a further zero padding of four zero bits. Finally, the upsampled signals are filtered through the bandpass filters 86, 88, and output from the IF upconverter 34 as intermediate frequency I and Q signals respectively.

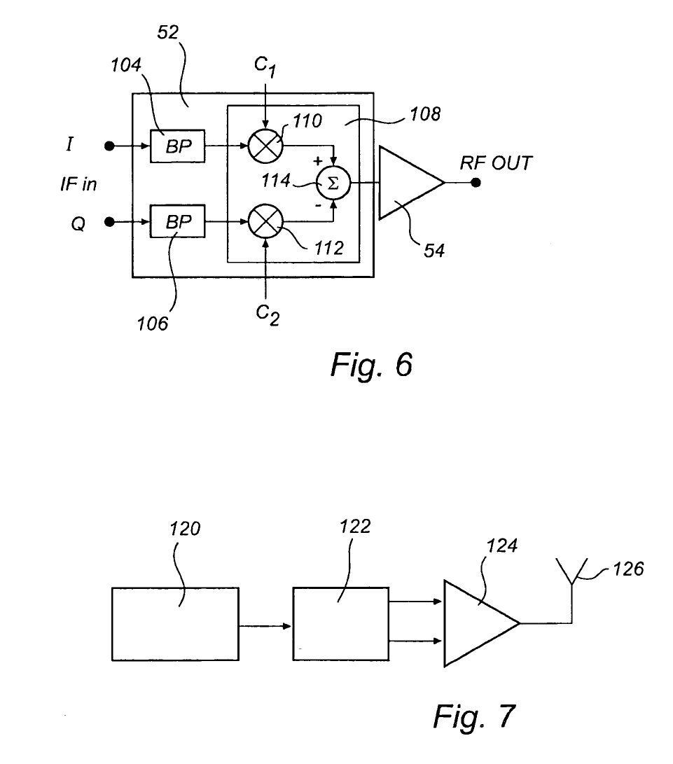

In an alternative embodiment of the envelope elimination and restoration device, the IF upconverter can be implemented in analogue circuitry, corresponding to the one shown in FIG. 6, see below, though with an intermediate carrier frequency. Further, the two step upsampling could alternatively be realised in one step.

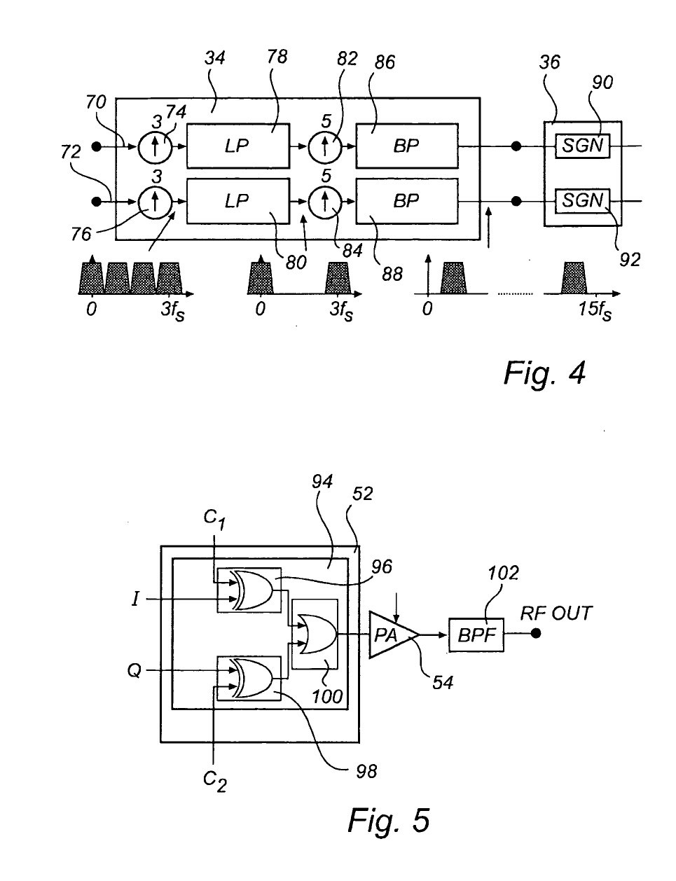

In FIG. 4 the signal spectra at three different locations of the inphase and quadrature paths, for the above given example, are schematically shown. Thus, the input I and Q signals are baseband signals, having a bandwidth of 20 MHz, in accordance with for example the IEEE 802.11a standard and the ETSI HiperLAN/2 standard, distributed about zero frequency. The sampling frequency f₃=20 MHz. After the first upsampling, the spectrum about 0 remains, and is repeated at 3fₛ, i.e. at 60 MHz, but the signals also comprise a number of spectral images at multiples of fₛ, as is illustrated by the leftmost spectral diagram in FIG. 4. After the lowpass filters 78, 80, two out of three images have been strongly attenuated as illustrated by the middle spectral diagram. The second upsampling also upconverts the signal frequency in order to avoid the zero frequency (ω_{α}=0). After bandpass filtering the spectral contents of the signal is as shown in the rightmost spectral diagram. The lowpass and bandpass filters 78, 80, 86, 88 are also called interpolation filters. Thus, the output signal, the modulated signal, of the IF upconverter 34 is a bandpass signal at an intermediate frequency and it still comprises an inphase signal and a quadrature signal.

The IF signal is fed to the clipping unit 36, which in the illustrated embodiment comprises a first and a second sign circuit, 90 and 92 respectively, extending a respective one of the inphase and quadrature paths 70, 72. The purpose of the clipping unit 36 is to provide a constant envelope signal, which will be used in the PA 54 to control the phase of the final RF output signal. Each sign circuit 90, 92 simply clips the signal around zero such that sgn(x)=+1 if x≧0, and sgn(x)=−1 if x<0.

The clipped I and Q signals are fed to the RF upconverter 52. As shown in FIG. 5, the RF upconverter 52 is fully digital and comprises an upconversion unit 94. The upconversion unit 94 comprises a first upconversion gate 96, which receives the clipped I signal at one input thereof, and a first carrier C₁ at another input thereof, a second upconversion gate 98, which receives the clipped Q signal at one input thereof, and a second carrier C₂ at another input thereof, and a subtraction gate 100, having a first input connected to an output of the first upconversion gate 96 and a second input connected to an output of the second upconversion gate 98. In this embodiment the first and second upconversion gates 96, 98 are implemented as logic EXOR circuits, since they correspond to mixers in a conventional analogue upconverter. The output signal of an EXOR gate will have the same spectrum, except at zero frequency, as the output signal of an analogue mixer. The reason for this is apparent from the following tables. The input signal, which is received from the clipping unit 36, takes the values +1 and −1. The analogue multiplication of such a signal is illustrated by:

| • | −1 | +1 |
|---|---|---|
| −1 | +1 | −1 |
| +1 | −1 | +1 |

For an EXCLUSIVE OR operation (⊕), which uses 0 and 1 as inputs, the corresponding table is:

| ⊕ | 0 | 1 |
|---|---|---|
| 0 | 0 | 1 |
| 1 | 1 | 0 |

It is obvious that the tables have the same structure. The only difference is the dc level at 0.5 (i.e. if 0 and 1 are equally likely). The first carrier C₁=(1+sgn{cos[(ωᵢ−k·2π·fₛ)t]})/2, and the second carrier C₂=(1+sgn{sin[(ωᵢ−k·2π·fₛ)t]})/2, where k is the total upconversion factor. In the above example, k=15.

The function to be performed by the subtraction gate 100 is to subtract the Q signal from the I signal. The difference may take one out of three different values, i.e. −1, 0 and +1. A binary gate performing such an operation does note exist. However, it is possible to approximate this operation with an OR gate. Thus, the output signal of the OR gate 100 is still a constant envelope square wave, though at radio frequency. Completing the above WLAN example, the frequency is 2.5 GHz. However, other frequencies are possible, depending on what system the envelope elimination and restoration device is to operate in. The RF signal is fed to the PA 54, where it is amplified while being modulated by the power control signal received at the PA 54 from the envelope path. The output signal of the PA 54 can then be filtered by means of a bandpass filter 102, in order to reduce spectral sidelobes.

In an alternative embodiment of the RF upconverter as shown in FIG. 6, the circuit implementation is analogue. Thus, the RF upconverter 52 as previously described has an I input and a Q input receiving the I and Q components of the IF signal respectively. However, first and second bandpass filters 104 and 106 are connected to the respective I and Q inputs. The outputs of the bandpass filters 104, 106 are connected to respective inputs of an upconversion unit 108, and more particularly to a first mixer 110 and a second mixer 112, respectively. The mixers 110, 112 are comprised in the upconversion unit 108. The first mixer 110 further has an input receiving a first carrier signal C₁, and the second mixer has an input receiving a second carrier signal C₂. In this embodiment the carrier signals are: C₁=cos[((ωᵢ−k·2π·fₛ)t], and C₂=cos[(ωᵢ−k·2π·fₛ)t], where k=15 for the same application example as above. The bandpass filters 104, 106 are analogue, and thus the output signals of the bandpass filters 104, 106 have a continuous amplitude distribution. Thus, the mixers can be of standard type. The output signal of the second mixer 112 is subtracted from the output signal of the first mixer 110 by means of a subtractor 114, which, for example, can be realized by means of a power splitter. Since both I and Q signals have been preserved up to the subtractor 114, no spectral image is produced at the upconversion, at least in an ideal case. The output of the adder 114 is connected to the PA 54, and is thus amplified as described above. Here, due to the bandpass filtering of the RF upconverter there is no need for a bandpass filter after the PA 54. The same is true for the digital embodiment described above, in applications where the requirements on channel separation are moderate.

As mentioned above, the inputs of the envelope extractor 32 can be connected to one of several points. Thus, rather than connecting them to the input terminal 26, they could alternatively be connected to the respective outputs of the lowpass filters 78, 80 of the IF upconverter 34, or to the outputs of the bandpass filters 86, 88 of the IF upconverter 34.

The inventive concept, embodied, for example, as the signal pre-processing device or as the whole envelope elimination and restoration device, is applicable to a large number of different radio communication devices, where it is provided in transmitters, as illustrated in FIG. 7, thus providing, or contributing to, a power efficient transmitter. The transmitter comprises an information source 120, a baseband processing unit 122, which is connected to the information source 120, the DEER device 124 according to this invention, which is connected to the baseband processing unit 122, and an antenna 126, connected to the DEER device 124. The baseband processing unit receives an information signal from the information source 120, and feeds I and Q signals, respectively, to the DEER device, which in turn provides the antenna with the final RF output signal which is transmitted.

Examples of such radio communication devices are WLAN devices, mobile phones, etc.

Above preferred embodiments of devices according to the present invention have been described. These should be seen as merely non-limiting examples. Many modifications will be possible within the scope of the invention as defined by the claims.

1. An envelope elimination and restoration device having an input terminal for receiving an input signal comprising an inphase signal and a quadrature signal, said envelope elimination and restoration device comprising:
a signal pre-processing device, which comprises a first path for processing the envelope of said input signal, and a second path for processing the phase of said input signal, said first path comprising a digital envelope extractor receiving said inphase and quadrature signals, and said second path comprising an intermediate frequency upconverter, receiving said input signal, and generating an intermediate frequency signal comprising said inphase and quadrature signals, and a digital clipping unit receiving said intermediate frequency signal;
a power control signal source having an input connected to an output of said envelope extractor;
a radio frequency upconverter connected to said digital clipping unit; and
a power amplifier having an input, which is connected to an output of said radio frequency upconverter, a power control input, which is connected to an output of said power control signal source, and an output.

2. An envelope elimination and restoration device according to claim 1, said power control signal source comprising a D/A converter and an amplifier.

3. An envelope elimination and restoration device according to claim 1,or said power control signal source comprising a sigma-delta D/A converter providing said input of the power control signal source, and a reconstruction filter having an input connected to an output of said sigma-delta D/A converter and providing said output of the power control signal source.

4. An envelope elimination and restoration device according to claim 1 said radio frequency upconverter comprising an upconversion unit, which comprises:
a first upconversion gate unit having a first input connected to a first output of said digital clipping unit, and a second input receiving a first digital upconversion signal; and
a second upconversion gate unit having a first input connected to a second output of said digital clipping unit, and a second input receiving a second digital upconversion signal.

5. An envelope elimination and restoration device according to claim 4, said upconversion unit further comprising a subtraction gate unit having a first input connected to an output of said first upconversion gate unit, and a second input connected to an output of said second upconversion gate unit.

6. An envelope elimination and restoration device according to claim 4 said subtraction gate unit comprising a logic OR circuit connected to said first and second inputs of the subtraction gate unit.

7. An envelope elimination and restoration device according to claim 4 said first upconversion gate unit comprising a first logic EXOR circuit connected to said first and second inputs of the first upconversion gate unit; and said second upconversion gate unit comprising a second logic EXOR circuit connected to said first and second inputs of the second upconversion gate unit.

8. An envelope elimination and restoration device according to claim 1, comprising a bandpass filter, an input thereof being connected to the output of said power amplifier.

9. An envelope elimination and restoration device according to of claim 1, said radio frequency upconverter comprising:
a first bandpass filter having an input connected to a first output of said digital clipping unit;
a second bandpass filter having an input connected to a second output of said digital clipping unit; and
an upconversion unit having a first input, which is connected to an output of said first bandpass filter, and a second input, which is connected to an output of said second bandpass filter.

10. An envelope elimination and restoration device according to claim 9, said upconversion unit comprising: a first mixer having a first input connected to said first input of the mixer unit, and a second input receiving a first analogue upconversion signal;
a second mixer having a first input connected to said second input of the mixer unit, and a second input receiving a second analogue upconversion signal;
and a subtractor having a first input connected to an output of said first mixer, and a second input connected to an output of said second mixer.

11. A signal pre-processing device having an input terminal for processing an input signal comprising an inphase signal and a quadrature signal, said preprocessing device comprising a first path for processing the envelope of said input signal, and a second path for processing the phase of said input signal, said first path comprising a digital envelope extractor receiving said inphase and quadrature signals, an output of the envelope extractor providing a first output of the preprocessing device, and said second path comprising an intermediate frequency upconverter, receiving said input signal, and generating an intermediate frequency signal comprising said inphase and quadrature signals, and a digital clipping unit receiving said intermediate frequency signal, an output of the clipping unit providing a second output of the pre-processing device.

12. A device according to claim 1, said intermediate frequency upconverter comprising an inphase path having a first input for receiving said inphase signal, and a quadrature path having a second input for receiving said quadrature signal, each path comprising a first up-sampler, and a second up-sampler.

13. A device according to claim 12, each one of said inphase and quadrature paths, respectively, further comprising a low pass filter connected between the first and second up-samplers, and a bandpass filter connected to an output of the second up-sampler.

14. A device according to claim 13, wherein said first and second up-samplers and said lowpass and bandpass filters are arranged such that the frequency content of the bandpass signals output from said bandpass filters comprise said inphase and quadrature signals.

15. A device according to claim 1, said digital envelope extractor being connected to said input terminal.

16. A device according to claim 1, said digital envelope extractor being connected to an output of said intermediate frequency upconverter.

17. A device according to claim 1, said digital envelope extractor being arranged for determining the square root of the sum of the square of said inphase signal and the square of said quadrature signal.

18. A communication device comprising an envelope elimination and restoration device according to claim 1.

19. A communication device comprising a signal preprocessing device according to claim 11.

20. A power efficient transmitter comprising an envelope elimination and restoration device according to claim 1.
